(19) United States
(12) Patent Application Publication
(10) Pub. No.: US 2018/0288071 A1
(43) Pub. Date: Oct. 4, 2018

(54) NON-TRANSITORY COMPUTER-READABLE STORAGE MEDIUM, DATA FILE TRANSMISSION METHOD, AND INFORMATION PROCESSING APPARATUS

(71) Applicant: FUJITSU LIMITED, Kawasaki-shi (JP)

(72) Inventors: Kazuyuki IKEDA, Nagareyama (JP); Yumiko NAKANO, Koto (JP)

(73) Assignee: FUJITSU LIMITED, Kawasaki-shi (JP)

(21) Appl. No.: 15/938,340

(22) Filed: Mar. 28, 2018

(30) Foreign Application Priority Data
Mar. 31, 2017 (JP) 2017-069560

(51) Int. Cl. H04L 29/06; H04L 12/58; G06F 17/30; G06F 21/56

(52) U.S. Cl. CPC H04L 63/145; H04L 51/08; G06F 2221/034; G06F 17/30076; G06F 21/565; G06F 17/30371

(57) ABSTRACT

A non-transitory computer-readable storage medium storing a program that causes a computer to execute a process, the process including transmitting to a source device an inquiry regarding a file name of a data file received from the source device, determining a consistency of the data file and the source device based on whether or not a file name corresponding to the file name of the data file is received from the source device in response to the inquiry, and transmitting, to a destination device of the data file, data to enable the data file when the data file and the source device are determined to be consistent in the determining.

### CROSS-REFERENCE TO RELATED APPLICATION

This application is based upon and claims the benefit of priority of the prior Japanese Patent Application No. 2017-69560, filed on Mar. 31, 2017, the entire contents of which are incorporated herein by reference.

### FIELD

The embodiment discussed herein is related to a non-transitory computer-readable storage medium, a data file transmission method, and an information processing apparatus.

### BACKGROUND

There exists a cyber attack called a targeted attack mail. The targeted attack mail is an attack made on a particular organization or the like, by transmitting an e-mail with an attachment file to an employee or the like of the targeted organization, for example. The attachment file of the targeted attack mail is an executable file or the like that is intended to infect a terminal device of a recipient with a computer virus, when the recipient opens the attachment file.

One of countermeasures against such targeted attack mails is use of security practice software or software having a filtering feature. These are configured to reduce transmission of dangerous e-mails and attachment files by blocking any likely targeted attack e-mail before the e-mail is transmitted to an addressed device. Another countermeasure is, for example, to give users a warning not to execute the attachment file inadvertently even if the users receive the targeted attack mail.

Related techniques are disclosed in, for example, Japanese Laid-open Patent Publication No. 2015-11561.

### SUMMARY

According to an aspect of the disclosure, a non-transitory computer-readable storage medium storing a program that causes a computer to execute a process, the process including transmitting to a source device an inquiry regarding a file name of a data file received from the source device, determining a consistency of the data file and the source device based on whether or not a file name corresponding to the file name of the data file is received from the source device in response to the inquiry, and transmitting, to a destination device of the data file, data to enable the data file when the data file and the source device are determined to be consistent in the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example illustrating a system configuration in this embodiment;

FIG. 2 is a functional block diagram illustrating a functional configuration of an MX server;

FIG. 3 is a functional block diagram illustrating a functional configuration of a controller;

FIG. 4 is a flow chart illustrating flow of processing to be performed by the MX server;

FIG. 5 is a diagram illustrating an example of information stored in a judgment rule information storage section;

FIG. 6 is a flow chart illustrating flow of a series of processing to be performed by the controller;

FIG. 7 is a diagram illustrating an example of information stored in a conversion rule storage section;

FIG. 8 is a diagram illustrating an example of information stored in an inquiry information storage section;

FIG. 9 is a diagram illustrating an example of an e-mail inquiring about a file name of an attachment file;

FIG. 10 is a flow chart illustrating flow of a series of processing to be performed by the controller after the inquiry processing is performed; and

FIG. 11 is a diagram illustrating an example of a hardware configuration of the controller in this embodiment.

### DESCRIPTION OF EMBODIMENT

As described above, utilization of security software or countermeasure software such as filtering of an e-mail is one of measures against a targeted attack mail. Under the current circumstances, however, it is not possible to follow a definition of the countermeasure software, and discrimination of the targeted attack mail from a legitimate mail, which is not the targeted attack mail, is not adequately fulfilled. This is because the targeted attack mail is not intended for an unspecified number and an attack is conducted aiming at a certain target. Thus, it may be impossible to make a correct judgment of risk of a data file such as an attachment file of the e-mail.

According to one aspect, it is desirable to attempt to improve a judgment precision to judge risk of the data file.

According to one aspect, the judgment precision to judge the risk of the data file may be improved.

An embodiment of the disclosure is described with drawings.

[Overview]

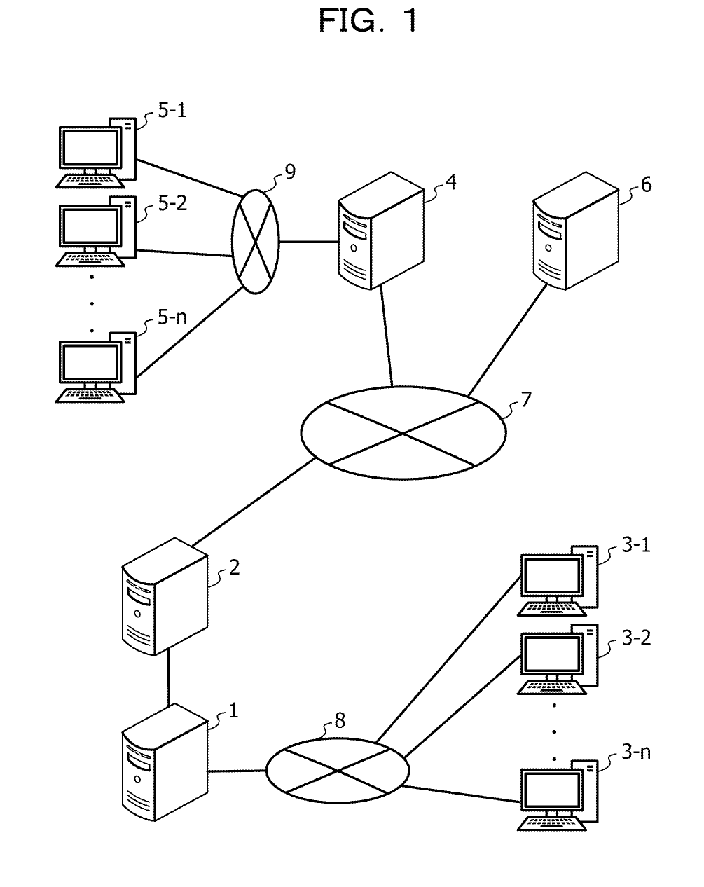

FIG. 1 is a diagram illustrating an example of a system configuration in this embodiment. FIG. 1 illustrates a controller 1, a Mail eXchanger (MX) server 2, terminal devices 3-1 to 3-n, a mail server 4, terminal devices 5-1 to 5-n, an external network 6, and networks 7, 8, 9.

The controller 1 performs control over transmission and reception processing of mails for the terminal devices 3-1 to 3-n. The controller 1 is communicatively connected to the terminal devices 3-1 to 3-n by wire or wirelessly, via the network 8. The controller 1 and the terminal devices 3-1 to 3-n are an intra-company system of a business, while the network 8 is an intra-company network. Here, the controller 1 may be a mail server in the intra-company system, or may be realized, as a hardware, by a computer such as a server device, for example.

The MX server 2 is a computer that is communicatively connected to the controller 1 by wire or wirelessly. The MX server 2 may perform filtering processing on mails to be transmitted or received for the controller 1 and the terminal devices 3-1 to 3-n. Processing to be performed by the MX server 2 in this embodiment is described below in detail. The MX server 2 may also be realized, as hardware, by a computer such as a server device, for example. Note that while FIG. 1 depicts the controller 1 and the MX server 2 as separate devices, the controller 1 and the MX server 2 may also be realized in one computer, as hardware.

Each of the terminal devices 3-1 to 3-n has a function to transmit or receive an e-mail with software such as a mailer or the like, which runs on an own device, for example. Each of the terminal devices 3-1 to 3-n is an information processor such as a personal computer (PC), a smart phone, a personal digital assistant (PDA), for example.

The mail server 4 is a mail server that is different from the controller 1 and lies outside of the network 8. The mail server 4 is communicatively connected to the terminal devices 5-1 to 5-n by wire or wirelessly. Each of the terminal devices 5-1 to 5-n may transmit e-mails addressed to other devices including the controller 1 or the terminal devices 3-1 to 3-n, by way of the mail server 4.

The external network 6 is an information processor outside of the network 8, and may transmit the e-mails addressed to the other devices including the controller 1 or the terminal devices 3-1 to 3-n. Here, note, however, that the e-mails to be transmitted from outside of the network 8, including the terminal devices 5-1 to 5-n and the external network 6, may include the targeted attack mails.

[Functional Configuration of the MX Server]

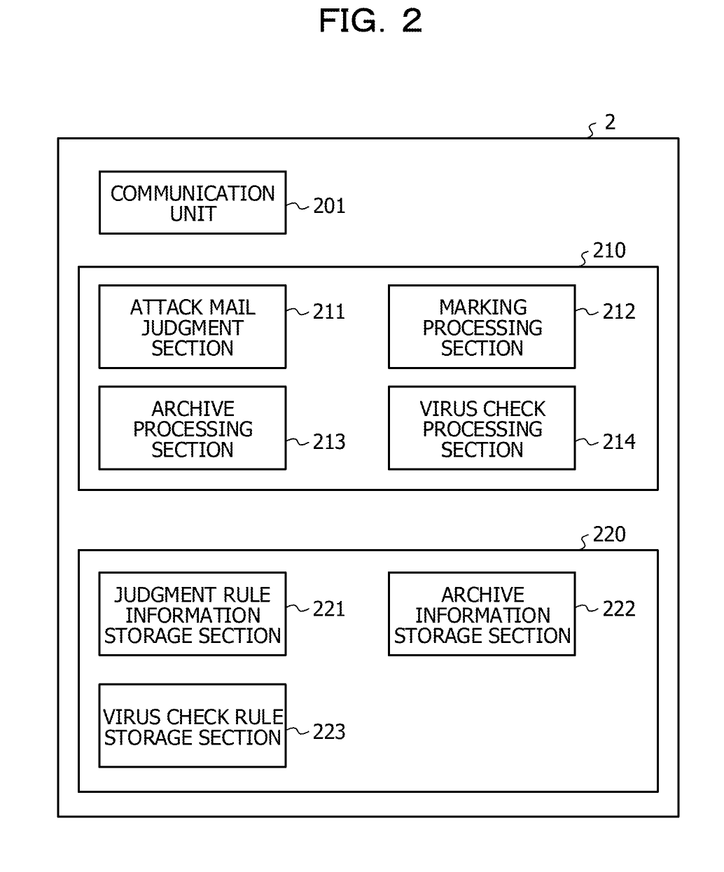

FIG. 2 is a functional block diagram illustrating a functional configuration of the MX server 2. The MX server 2 includes a communication unit 201, a processing unit 210, and a storage unit 220, for example.

The communication unit 201 may perform communications with the other devices including the controller 1, by wire or wirelessly. The communication unit 201 is, for example, a communication device such as a network adaptor or a network interface controller (NIC) that the MX server 2 includes.

The processing unit 210 includes an attack mail judgment section 211, a marking processing section 212, an archive processing section 213, and a virus check processing section 214.

The attack mail judgment section 211 analyzes content of an e-mail addressed to the controller 1 or the terminal devices 3-1 to 3-n, via the network 7, and judges whether or not the e-mail is a likely targeted attack mail.

The marking processing section 212 is a processing section that adds information (hereinafter referred to as “marking”) to the e-mail judged as the likely targeted attack mail by the attack mail judgment section 211, the information making the e-mail recognizable as the likely targeted attack mail.

The archive processing section 213 is a processing section that performs processing to save the e-mail judged as the likely targeted attack mail by the attack mail judgment section 211. However, the archive processing section 213 may also save any e-mails judged as the likely targeted attack mail.

The virus check processing section 214 is a processing section that performs a virus check on the e-mail addressed to the controller 1 or the terminal devices 3-1 to 3-n via the network 7.

The storage unit 220 includes a judgment rule information storage section 221, an archive information storage section 222, and a virus check rule storage section 223.

The judgment rule information storage section 221 is a storage section that stores a judgment rule to be used in judgment processing to be performed by the attack mail judgment section 211.

The archive information storage section 222 is a storage section that stores information on the e-mail saved by the archive processing section 213.

The virus check rule storage section 223 is a storage section that stores a check rule of a virus check to be performed by the virus check processing section 214.

[Functional Configuration of the Controller 1]

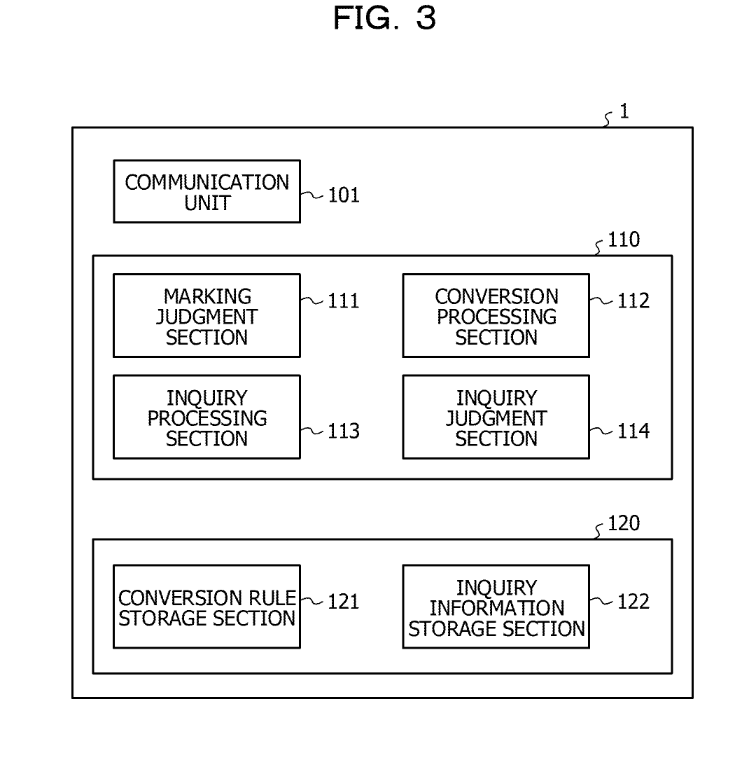

FIG. 3 is a functional block diagram illustrating a functional configuration of the controller 1. The controller 1 includes a communication unit 101, a processing unit 110, and a storage unit 120, for example.

The communication unit 101 may perform communications with other devices including the MX server 2 and the terminal devices 3-1 to 3-n, by wire or wirelessly. The communication unit 101 is a communication device such as the network adaptor or the NIC that the controller 1 includes.

The processing unit 110 includes a marking judgment section 111, a conversion processing section 112, an inquiry processing section 113, and an inquiry judgment section 114.

The marking judgment section 111 performs processing to judge whether or not marking is provided on an e-mail received by way of the MX server 2 by the marking processing section 212.

The conversion processing section 112 performs processing to convert a file name of an attached mail attached to the e-mail that is judged as marked by the marking judgment section 111.

The inquiry processing section 113 identifies a sender of the e-mail judged as marked by the marking judgment section 111, and transmits an inquiry about the file name of the attachment file to the identified sender. While details are described below, in this embodiment, the inquiry processing section 113 transmits to the identified sender an e-mail inquiring about the file name of the attachment file attached to the e-mail. Note that the inquiry processing section 113 is one aspect of a transmission unit.

When receiving a reply to the inquiry e-mail, the inquiry judgment section 114 analyzes content of the received reply mail to judge whether or not there is a reply to the inquiry or whether the reply is correct or wrong. Note that the inquiry processing section 113 is one aspect of the judgment section.

The storage unit 120 includes a conversion rule storage section 121 and an inquiry information storage section 122.

The conversion rule storage section 121 is a storage unit that stores a conversion rule when the conversion processing section 112 converts the file name of the attachment file.

The inquiry information storage section 122 stores information on the e-mail on which the inquiry by the inquiry processing section 113 is performed.

Details of the respective processing sections and storage sections of the controller 1 and the MX server 2 mentioned above are described below in a detailed description of processing to be performed by each of the devices.

[Processing in the MX Server 2]

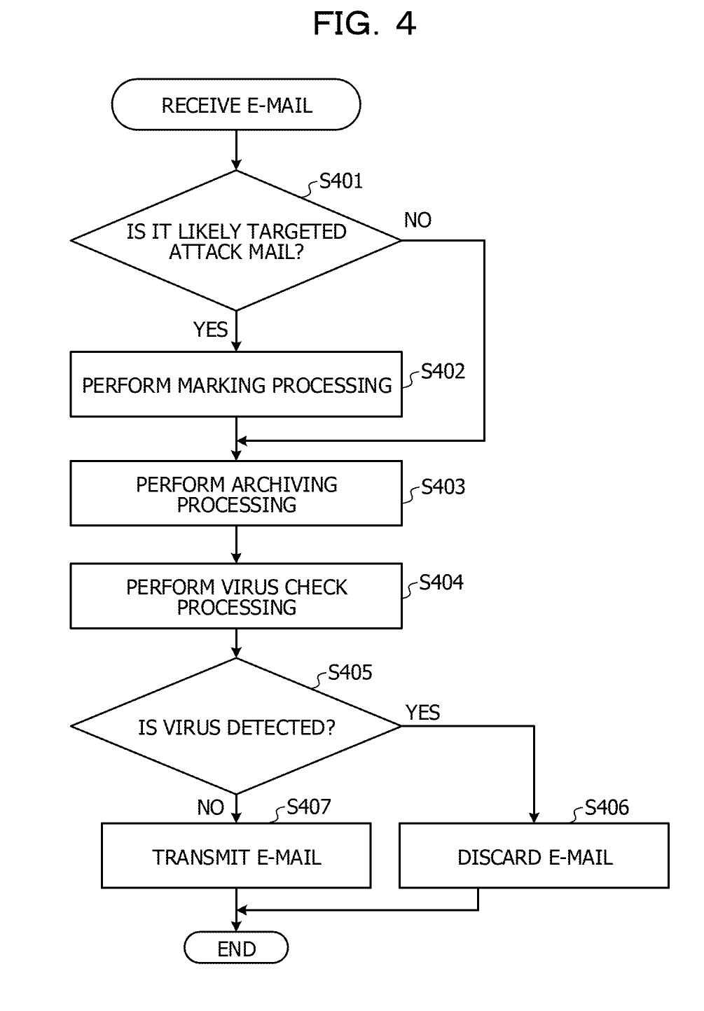

FIG. 4 is a flow chart illustrating flow of the processing to be performed by the MX server 2. In this embodiment, if an e-mail addressed to the controller 1 or the terminal device 3-1 to 3-n is transmitted, the e-mail is first received by the MX server 2. Then, triggered by the MX server 2 receiving the e-mail with an attachment file, a series of processing illustrated in FIG. 4 is started.

First, the attack mail judgment section 211 judges whether or not the received e-mail is a likely targeted attack mail (step S401). Specifically, for example, the attack mail judgment section 211 analyzes content of the received e-mail and judges whether or not the e-mail includes content that matches any of conditions stored in the judgment rule information storage section 221.

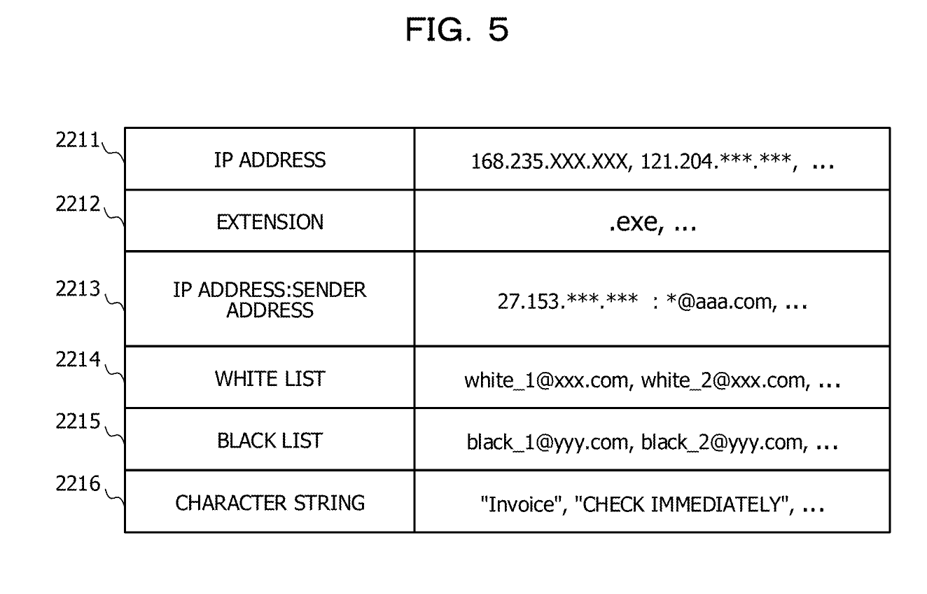

FIG. 5 is a diagram illustrating an example of information stored in the judgment rule information storage section 221. The judgment rule information storage section 221 stores judgment conditions to judge whether or not the e-mail is a likely targeted attack mail. The judgment conditions include, for example, an IP address 2211, an extension 2212, an IP address:sender address 2213, a white list 2214, a black list 2215, and a character string 2216 as illustrated in FIG. 5.

The IP address 2211 is an IP address condition to judge that the e-mail is a likely targeted attack mail if the e-mail falls under the condition. For the condition, a specific individual IP address may be set or a condition, such as “121.204.***.*** (* is a wild card)” of FIG. 5, which is in a partially matched format, may be set.

The extension 2212 is a condition for an extension of the attachment file to be judged as a likely targeted attack mail. For example, the extension that is easily used in a malicious data file intended to infect with a computer virus may be set as the condition. In FIG. 5, by way of example, an extension “.exe” is included in the condition.

The IP address:sender address 2213 makes a combination of an IP address and a sender's mail address the judgment condition. In this manner, the attack mail judgment section 211 may also perform the judgment processing based on a combination of specific IP address and sender's mail address, rather than judging simply based on the IP address.

The white list 2214 is a condition for a sender's mail address of an e-mail not to be judged as a likely targeted attack mail, irrespective of whether or not the e-mail falls under any other condition.

The black list 2215 is a condition for a sender's mail address of an e-mail to be judged as a likely targeted attack mail, irrespective of whether or not the e-mail falls under any other condition.

The character string 2216 is a condition for a character string to judge that the e-mail is a likely targeted attack mail if the character string is included in a subject line or a text of the e-mail. In this embodiment, if the character string “Invoice” or “Check immediately” is included in the subject line or the text of the e-mail, the attack mail judgment section 211 judges that the e-mail is a likely targeted attack mail.

Using the conditions described above, the attack mail judgment section 211 may judge whether or not the received e-mail is a likely targeted attack mail. For example, the attack mail judgment section 211 judges that an e-mail that falls under one or more of the conditions mentioned above is an e-mail likely to be a targeted attack mail. In addition to this, judgment results of antispam software or junk mail judgment software, for example, may be utilized together. However, the judgment conditions mentioned above are just illustrative of the judgment conditions and may be changed appropriately.

With reference back to the description of FIG. 4, as a result of the judgment in step S401, if it is judged that the received e-mail is not a likely targeted attack mail (step S401, NO), processing of step S403 is performed.

On the other hand, if it is judged that the received e-mail is a likely targeted attack mail (step S401, Yes), the marking processing section 212 performs marking processing on the received e-mail (step S402). The marking processing is to add information to an e-mail, information enabling the controller 1 to recognize that the e-mail is a likely targeted attack mail receiving the e-mail. For example, in the e-mail, an item stated in a format of “x-oo (any character string)” may be arbitrarily added to header information of the e-mail. Then, in this embodiment, for example, the header information of a header name of “X-t_threat” is added to the e-mail judged as a likely targeted attack mail. Note that the character string of the header name is just an example, and any header name other than the example may be used as far as the header name does not overlap other header name added to the e-mail. After step S402 is performed, processing of step S403 is performed.

In step S403, the archive processing section 213 stores content of the received e-mail in the archive information storage section 222 (step S403). Here, the archive processing section 213 may store contents of all of received e-mails or store only contents of the e-mails judged as a likely targeted attack mail, of the received e-mails.

After the processing of step S403 is performed, the virus check processing section 214 performs the virus check on the received e-mail (step S404). The virus check may also be performed according to a virus definition stored in the virus check rule storage section 223.

As a result of the virus check in step S404, the virus check processing section 214 judges whether or not the virus (computer virus) is detected in the received e-mail (step S405). If the virus is detected in the e-mail (step S405, YES), the received e-mail is discarded in the MX server 2 in order to suppress virus infection and not transmitted to the controller 1 (step S406). On the other hand, if no virus is detected in the e-mail (step S405, NO), the received e-mail is transmitted to the controller 1 via the communication unit 201 (step S407). After step S406 or S407 is performed, the series of processing illustrated in FIG. 4 ends. Note that the processing of the virus check described in steps S404 to S406 is arbitrary, and may be omitted in consideration of processing load on the MX server 2.

[Processing in the Controller 1]

Processing to be performed by the controller 1 when an e-mail is received by way of the MX server 2 is described hereinafter.

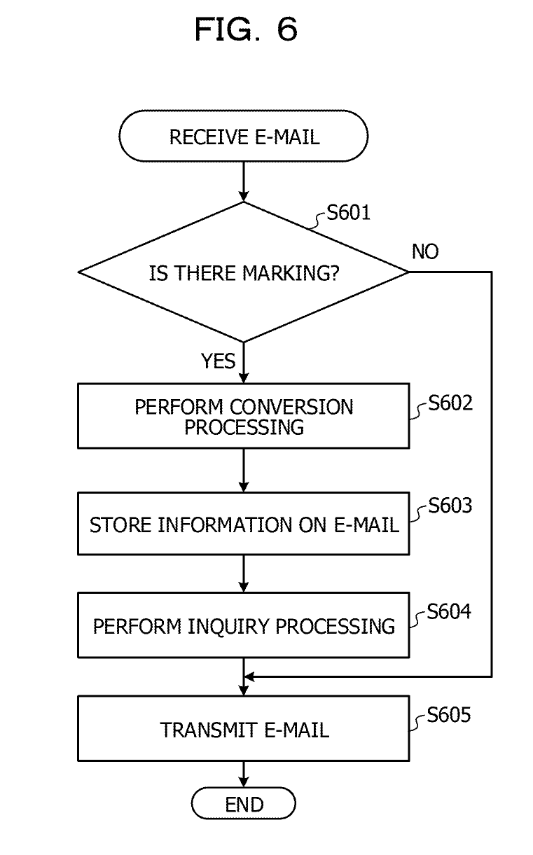

FIG. 6 is a flow chart illustrating flow of a series of the processing to be performed by the controller 1. First, the marking judgment section 111 judges whether or not marking is provided on the received e-mail (step S601). In this embodiment, if the received e-mail is a likely targeted attack mail, the header information is added to the e-mail by the marking processing section 212, as described above. Thus, the marking judgment section 111 judges whether or not the received e-mail includes the header information (“X-t_threat” as mentioned above, for example) indicating that the e-mail is a likely targeted attack mail. More specifically, it may be said that processing of step S601 is processing for the controller 1 to judge whether or not the received e-mail is a likely targeted attack mail. If no marking is provided on the received e-mail (step S601, NO), processing of S605 is performed.

If the marking is provided on the received e-mail (step S601, YES), the conversion processing section 112 generates a data file (hereinafter referred to as a “replaced file”) (step S602), by changing a file name of an attachment file attached to the received e-mail. Here, the conversion processing section 112 performs processing so that changing the file name changes or deletes an extension of the attachment file.

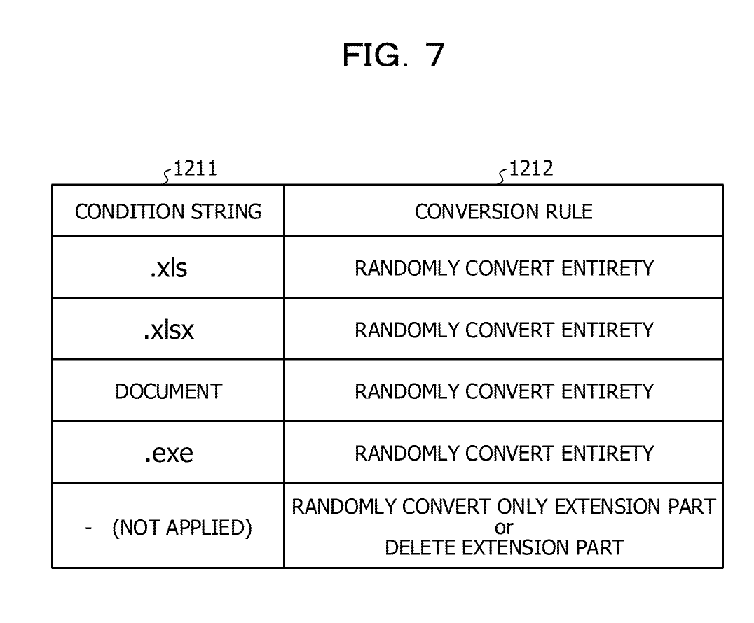

FIG. 7 is diagram illustrating an example of information stored in the conversion rule storage section 121. Conversion of the file name by the conversion processing section 112 is performed based on the information stored in the conversion rule storage section 121. As illustrated in FIG. 7, for example, the conversion rule storage section 121 stores the condition character strings 1211 and conversion rules 1212 while associating them each other.

The condition character string 1211 is information indicating the character string in the attachment file that is used as the condition to decide the conversion rule. If the file name of the attachment file (including the extension) includes the character string indicated in the condition character string 1211, the conversion processing of the file name is performed, using the conversion rule 1212 associated with the character string.

In the description on the example illustrated in FIG. 7, for example, if a character string “.xls” is included in the file name of the attachment file (the extension is “.xls”), “randomly convert entirety” is applied as the conversion rule. In this embodiment, the “randomly convert entirety” is the conversion processing by which the character string of the entire file name including the extension is changed randomly. Furthermore, even if a character string “.xlsx” is included in the file name of the attachment file (the extension is “.xlsx”), the “randomly convert entirety” is used as the conversion rule. This is because it is believed that for files having the extension of “.xls” or the “.xlsx”, in many cases, it may be relatively easy to estimate from file names such as “oo budget” or “oo total” (oo is any character string) that the files have the extension of “.xls” or the “.xlsx”. Consequently, in order to make it difficult to estimate the extension from the file name, the conversion processing section 112 randomly changes the character string in the entire file name including the extension.

In addition, if the file name of the attachment file includes a character string “document”, the “randomly convert entirety” is also applied. This is because it is believed that if the file name includes the character string “document”, the extension of that file is highly likely to be the extension related to a word processing application, and thus it is highly likely that the extension may be estimated relatively easily from the file name.

If the file name of the attachment file includes a character string of “.exe” (the extension is “.exe”), the “randomly convert entirety” is used as the conversion rule. This is because it is believed that the attachment file in an executable file format is highly likely to be a malicious file to infect a computer, which executes the attachment file, with the computer virus. Thus, the conversion processing section 112 randomly changes the character string of the entire file name including the extension, so that the file name including the extension may not be easily identified, more specifically, the attachment file is not easily executed. In addition, such randomly change of the file name generates a file name which makes the content of the attachment file difficult to identify, and thereby produces an effect of encouraging the users of the terminal devices that receive the attachment file to pay careful attention to the attachment file.

If the file name of the attachment file does not include any character string indicated in the condition character strings 1211 (“—(Not applied)” is presented in FIG. 7), the conversion processing section 112 randomly changes only an extension part of the file name. Alternatively, the conversion processing section 112 deletes the extension part of the file name from the file name. In this case, by the extension being converted or deleted, the conversion processing section 112 makes it impossible to open the attachment file with an as-is file name. On the other hand, taking into account the possibility that the attachment file and the e-mail to which the attachment file is attached are legitimate, the character string of the original file name is left in the character string excluding the extension, and thereby is put in such a state that the content of the attachment file may be estimated to some extent.

As described above, in this embodiment, the conversion processing section 112 may select the conversion rule to apply from a plurality of conversion rules, according to an aspect of the file name of the attachment file. However, the conversion processing of the file name may be in such an aspect that a uniform conversion rule of randomly changing the character string in the entire file name including the extension, without relying on the file name, is applied. In addition, a correspondence relationship between the character string in the file name and the conversion rules may take a different form from the illustration depicted in FIG. 7.

The extension of the attachment file being changed or deleted, as described above, releases association with an application that is used when the attachment file is executed. This makes it impossible for the terminal device that receives the e-mail to execute the attachment file attached to the e-mail with the as-is file name (in a state subjected to the conversion processing). Even if the attachment file attached to the e-mail is a dangerous data file, this may restrain the terminal device that receives the e-mail from inadvertently executing the attachment file. Furthermore, after ensuring that the same extension as the extension (original extension) of the file name before being converted is not appended to the file name after being converted, the conversion processing section 112 may finalize the file name after being converted. Alternatively, after ensuring that any existing extension is not appended to the file name after being converted, the conversion processing section 112 may finalize the file name after being converted. This is to avoid a situation in which as a result of the random character conversion, the extension is accidentally appended to the attachment file, which makes it possible for the terminal device to open the attachment file.

After processing of step S602 is performed, the inquiry processing section 113 stores in the inquiry information storage section 122 information on the e-mail for which the replacement file is generated (step S603).

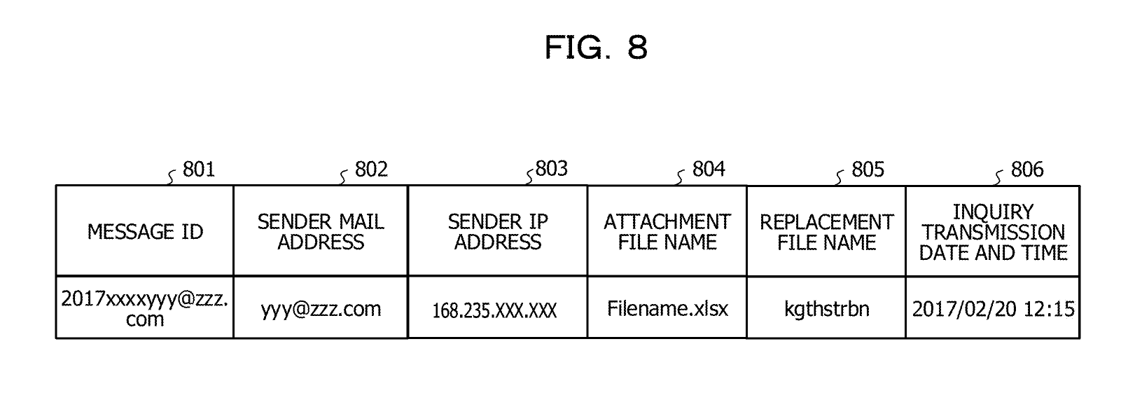

FIG. 8 is a diagram illustrating an example of information stored in the inquiry information storage section 122. The inquiry information storage section 122 stores, for one e-mail, a message identifier (ID) 801, a sender mail address 802, a sender internet protocol (IP) address 803, an attachment file name 804, a replacement file name 805, and an inquiry transmission date and time 806. Furthermore, while FIG. 8 illustrates information on the one e-mail, the inquiry information storage section 122 stores information on a plurality of e-mails if there are the plurality of e-mails for which replacement files are generated.

The message ID 801 is identification information that makes each of e-mails uniquely identifiable and is included as meta data in each of the e-mails. Note that the message ID 801 may be replaced with any information different from the message ID, as far as the information may uniquely identify each of the e-mails.

The sender mail address 802 is information representative of a mail address of the sender of the e-mail. Noted, however, that for the mail address stored as the sender mail address 802, the sender may be possibly faked by a malicious sender.

The sender IP address 803 is information representative an IP address of the sender of the e-mail.

The attachment file name 804 is information representative of the file name (including the extension) of the attachment file attached to the e-mail. Note that the file name indicated in the attachment file name 804 is the file name before being converted by the conversion processing section 112 (at the time of when the e-mail is received).

The replacement file name 805 is information representative of the file name after being changed by the conversion processing section 112, of the file name of the attachment file attached to the e-mail.

The inquiry transmission date and time 806 is information representative of timing when the inquiry processing of step S604, to be described below, is performed.

The controller 1 stores various types of information as described above and manages e-mails, for each of the e-mails for which it is determined that the marking is provided.

After step S603 is performed, the inquiry processing section 113 performs the inquiry processing to the sender of the e-mail (step S604). Specifically, for example, the inquiry processing section 113 transmits to the mail address indicated in the sender mail address 802 an inquiry e-mail about the file name of the attachment file attached to the e-mail.

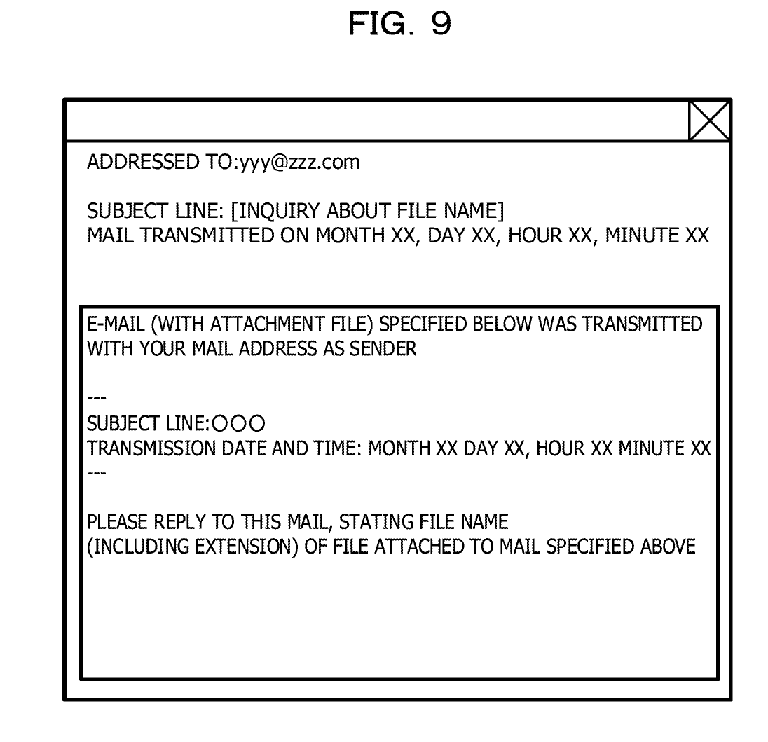

FIG. 9 is a diagram illustrating an example of the e-mail inquiring about the file name of the attachment file. For example, the inquiry processing section 113 transmits the e-mail, as illustrated in FIG. 9, including the subject line and the transmission date and time of the e-mail to which the attachment file is attached, with the sender of the e-mail as a contact, requesting the contact to transmit a reply (answer) including the attachment file name. Based on whether or not there is the reply to the inquiry e-mail or content of the reply, the controller 1 may judge legitimacy of the e-mail to which the attachment file is attached (Details are described below). Furthermore, FIG. 9 is an example of the inquiry about the attachment file name, and an aspect of the e-mail is not desirably identical to the aspect illustrated in FIG. 9. In addition, the inquiry processing section 113 may make an inquiry using any application or communication tool other than the e-mail.

After step S604 is performed, processing of step S605 is performed. In step S605, the controller 1 transmits the e-mail, which is received via the MX server 2, to the terminal device to which the e-mail is addressed, of the terminal devices 3-1 to 3-n via the communication unit 101. Alternatively, the controller 1 delivers the e-mail, which is received via the MX server 2, to a mail box of a user to whom the e-mail is addressed. Furthermore, if the e-mail that is transmitted or delivered here is the e-mail on which it is determined in step S601 that the marking is provided, the file name of the attachment file attached to the e-mail is changed to the file name indicated in the replacement file name 805.

After the processing of step S605 is performed, the series of processing illustrated in FIG. 6 ends. Furthermore, for the e-mail wherein the file name of the attachment file is changed by the processing of step S602, processing of steps S603 to S605 may be performed in a different sequence from the illustration described earlier or may be performed in parallel.

As described above, in this embodiment, if it is judged that the received e-mail is a likely targeted attack mail, the controller 1 changes the file name of the attachment file attached to the e-mail. Then, as the extension of the attachment file is also changed, the user of the terminal device that receives the e-mail may not open the attachment file at the time of reception. This may avoid opening of the data file even if the attachment file is, for example, the dangerous data file intended to infect the terminal device with the computer virus. On the other hand, the e-mail with the attachment file is transmitted to the addressed terminal device although the file name is changed. Thus, unlike the existing mail filtering, the user of the terminal device may become aware that the e-mail addressed to the user is transmitted.

[Determination of the Legitimacy of the e-Mail]

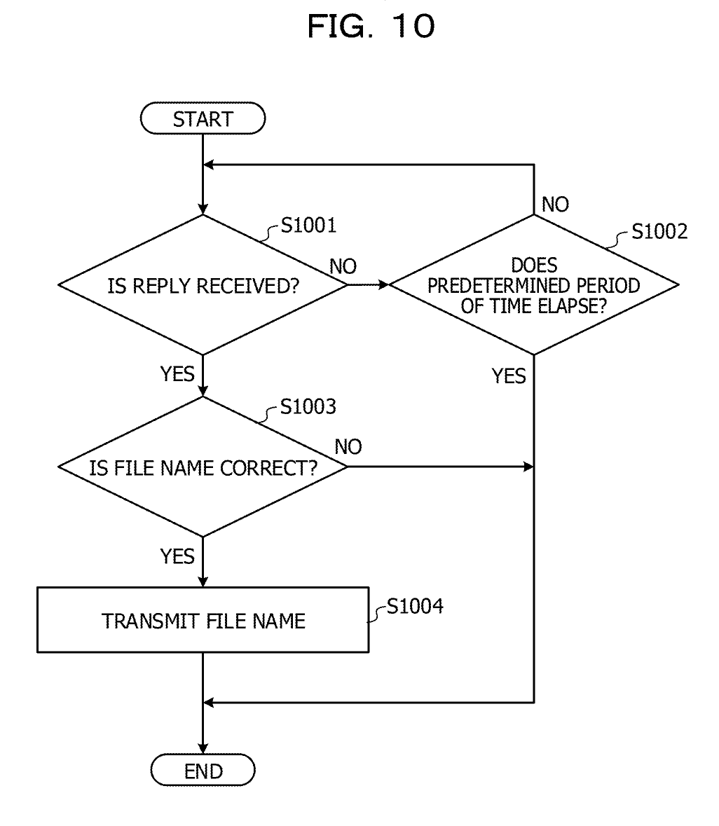

FIG. 10 is a flow chart illustrating flow of a series of processing to be performed by the controller 1 after the inquiry processing is performed. The series of processing illustrated in FIG. 10 is performed on each of the e-mails for which the inquiry processing is performed, for example, being triggered by execution of the inquiry processing.

First, the inquiry judgment section 114 judges whether or not the reply to the transmitted inquiry is received (step S1001). For example, if the inquiry is made by use of the e-mail, the inquiry judgment section 114 judges whether or not the reply e-mail to the inquiry e-mail is received. If the reply to the transmitted inquiry is received (step S1001, YES), processing of step S1003 is performed.

On the other hand, if the reply to the transmitted inquiry is not yet received at that time (step S1001, NO), for the e-mail, which is a target of processing, the inquiry judgment section 114 judges whether or not a predetermined period of time elapses since a date and time indicated in the inquiry transmission date and time 806 stored in the inquiry information storage section 122 (step S1002). If the predetermined period of time does not elapse (step S1002, NO), processing of step S1001 is performed. On the other hand, if the predetermined period of time elapses (step S1002, YES), for the e-mail, which is the target of processing, the series of processing illustrated in FIG. 10 ends. In this case, processing of step S1004, to be described below, is not performed.

In step S1003, the inquiry judgment section 114 judges whether or not the file name indicated in the received reply is correct (step S1003). For example, if the inquiry is made by use of the e-mail, the inquiry judgment section 114 refers to a value of the attachment file name 804 stored in the inquiry information storage section 122. Then, the inquiry judgment section 114 judges whether or not a character string that matches the character string indicated in the attachment file name 804 (that is to say, the file name before being changed) is included in a text of the reply e-mail to the inquiry. It may be said that the processing of step S1003 is one of approaches to judge consistency of the attachment file with the sender of that attachment file. Furthermore, a criterion to judge that the file name is correct may also be that the character string that perfectly matches the file name before being changed is included in the text of the reply e-mail to the inquiry. Alternatively, even if the character string does not perfectly match, it may also be judged that the file name is correct, as far as the file name is identifiable as a substantially same file name even if there are some differences such as full-width or half-width characters.

If it is judged that the character string that matches the character string indicated in the attachment file name 804 is not included in the text of the reply e-mail, the inquiry judgment section 114 judges that the file name indicated in the received reply is not correct (step S1003, NO). If the file name indicated in the received reply is not correct, for the e-mail, which is the target of processing, the series of processing illustrated in FIG. 10 ends. In this case, the processing of step S1004, to be described below, is not performed.

On the other hand, if it is judged that the character string that matches the character string indicated in the attachment file name 804 is included in the text of the reply e-mail, the inquiry judgment section 114 judges that the file name indicated in the received reply is correct (step S1003, YES). Then, for the e-mail, which is the target of processing, the inquiry judgment section 114 transmits the file name indicated in the attachment file name 804, that is to say, the file name before being changed, to the terminal device to which the e-mail, which is the target of processing, is addressed (step S1004). To transmit the file name, for example, the e-mail may be used, or the file name may be transmitted in any transmission method that is different from the e-mail. Alternatively, the controller 1 may transmit the attachment file whose file name is changed again to the file name before being changed, to the terminal device to which the e-mail, which is the target of processing, is addressed, via the communication unit 101. In such a case, so as to be able to identify association between the original e-mail and attachment file, the subject line or the transmission date and time or the like of the e-mail to which the attachment file is originally attached may be included in the subject line or the text of the e-mail to which the attachment file is attached. Data of the attachment file may be obtained from the archive information storage section 222 of the MX server 2. However, the controller 1 itself may also retain the data of the attachment file, together with the information illustrated in FIG. 8.

After the processing of step S1004 ends, for the e-mail, which is the target of processing, the series of processing illustrated in FIG. 10 ends.

Technical significance of the processing of this embodiment mentioned above is now described. There exists the mail filtering, for example, as a countermeasure against the targeted attack mails. However, it is likely that the mail filtering may fail to appropriately block damages by a targeted attack mail, the content of which is more sophisticated. More specifically, because the content is sophisticated, the content of the e-mail may not enable an easy judgement on whether or not the e-mail is the targeted attack mail. Thus, a case may occur in which it is not possible to block the targeted attack mail or in which even legitimate e-mails are blocked due to excessive filtering.

As described above, for the targeted attack mail that may not be blocked, if the user may correctly determine that the e-mail is dangerous, the damages may be obviated. In the targeted attack mail, however, the sender may be faked so that the sender of the e-mail may not be identified. For example, the mail address of the sender of the e-mail differs from the original mail address and is faked to be a mail address that seems related to the recipient. In this case, because the attachment file is such disguised that the attachment file is not dangerous to the recipient (the attachment file is transmitted from a reliable sender), it is likely that the recipient opens the attachment file without noticing that the attachment file is of the targeted attack mail. It is believed that the faking of the sender or the like makes it more difficult for the users who receive the e-mail to distinguish the targeted attack mail.

Hence, in this embodiment, the controller 1 transmits the inquiry about the file name of the attachment file to the sender of the e-mail judged as a likely targeted attack mail. Then, unlike the conventional mail filtering or the like, the controller 1 judges consistency of the e-mail and the attachment file with the sender, based on a result of the reply to the inquiry.

In the case of the e-mail whose sender is faked, the inquiry to the sender indicated in the e-mail is transmitted to an addressee that is different from the authentic sender. Thus, it is possible that a user of a receiver who receives the inquiry may not reply to the inquiry because the user receives the inquiry about the e-mail that is not transmitted by the user. In this case, a result is such that reception of the file name of the attachment file from the sender is not detected. Alternatively, even if the user of the receiver replies to the inquiry, it is still not possible to know the file name which is a correct answer, because the user does not actually transmit the e-mail. Thus, it is considered that the reply result is different from the correct answer. Note that these events correspond to YES of step S1002 and NO of step S1003 in FIG. 10, which may be said to be a state in which the attachment file and a destination of that attachment file are inconsistent.

As such, in this embodiment, for the attachment file received, as a judgment is made on the consistency of the e-mail and the attachment file with the sender, it is expected that the judgment precision of the risk of the attachment file is improved.

In this embodiment, the MX server 2 judges whether or not the received e-mail is a likely targeted attack mail. Nevertheless, even the e-mail that is judged as a likely targeted attack mail is transmitted to the addressed terminal device after the file name of the attachment file is changed. The e-mail that is judged as a likely targeted attack mail by the MX server 2 and has the sender faked is highly likely to be a dangerous e-mail aiming at attacking the address of the e-mail. In this embodiment, however, if it is judged that the sender of the e-mail is faked, the file name remains changed so that the terminal device at the e-mail address may not open the attachment file. Therefore, it is possible to reduce infection with the computer virus at the terminal device due to opening of the attachment file.

On the other hand, if the file name that matches the file name before being changed is obtained as the reply result, it may be determined that the sender of the e-mail judged as a likely targeted attack mail matches the destination of the inquiry. Then, the controller 1 judges that the e-mail once judged as a likely targeted attack mail is a legitimate e-mail and notifies the terminal device of the e-mail address of the file name of the attachment file before being changed, that is to say, the authentic file name. This allows the terminal device at the e-mail address to open the transmitted attachment file using the authentic file name including the extension.

As described above, in this embodiment, the controller 1 judges that an e-mail received by the controller 1 is a legitimate e-mail, based on information on of the attachment file of the e-mail, the information indicating the matching of the file name before being change and the file name included in the inquiry reply. The terminal device at the e-mail address may open the attachment file attached to the e-mail that is judged as legitimate.

In addition, in the conventional mail filtering, as a result of increasing filtering level to suppress occurrence of the targeted attack mails that may not be blocked, it is likely that even legitimate mails may be blocked. To address this, according to this embodiment, even the e-mail that is once judged as a likely targeted attack mail is transmitted to the addressed terminal device after the file name of the attachment file is changed. Therefore, this may restrain the legitimate mails from being blocked by the mail filtering.

As one of the mail filtering aspects, for example, filtering based on the character string included in the subject line of the e-mail is possible. By way of example, while it is considered that the character string “invoice” is likely to be included in the subject line of the targeted attack mail, it is also considered that the character string “invoice” is frequently used in the subject line of the legitimate mail related to operations. Thus, if a condition that “the character string ‘invoice’ is included in a subject line of an e-mail” is added to filtering conditions of the mail filtering, the legitimate mail related to the operations may be totally blocked. In this embodiment, however, even the e-mail like this may be transmitted to the address and the attachment file may be opened as far as legitimacy of the e-mail may be confirmed through the inquiry about the attachment file name.

Furthermore, in this embodiment, in order to restrain the attachment file from being inadvertently opened at the terminal device, processing to convert the file name of the attachment file and then transmit is performed. In such a case, a mailer to be introduced to the terminal devices 3-1 to 3-n may be realized even without alteration of software. More specifically, as a general-purpose mailer may be utilized for the mailer to be introduced to the terminal devices 3-1 to 3-n, there is also an advantage of controlling a sharp increase in implementation cost when the mailer is applied to an information processing system.

In this embodiment, a combination of the judgment processing of whether or not the e-mail is the targeted attack mail, which is performed in the MX server 2, and the inquiry processing about the file name, which is performed in the controller 1, enables improvement of the judgment precision of the targeted attack mails. Based on this standpoint, as a variation of this embodiment, an aspect is also possible in which, for example, the transmission (corresponding to step S605 of FIG. 6) of the e-mail judged as a likely targeted attack mail is not performed, and the e-mail is transmitted after it is judged (corresponding to step S1004 of FIG. 10, for example) through the inquiry processing that the e-mail is legitimate. In this case, it is possible to attain a technical effect of enhancing the judgment precision of the targeted attack mails, when compared with the conventional mail filtering, although the e-mail judged as a likely targeted attack mail is once blocked.

In this embodiment, while the controller 1 and the MX server 2 perform processing on the e-mail addressed to the terminal devices 3-1 to 3-n, from the standpoints of the object and effects of this embodiment, various types of the processing described in this embodiment may be performed internally in each of the terminal devices 3-1 to 3-n.

In addition, in this embodiment, while the description is provided with the attachment file attached to the e-mail as an example, the judgment of risk of the data file based on the consistency of the data file and the sender is also effective in any case other than the cases exemplified in this embodiment. Even in a condition in which the data file is transmitted and received without the e-mail, there are many cases in which the IP address or a media access control (MAC) address is faked in a malicious attack. It may be said, therefore, that the judgment of the risk of the data file based on the consistency of the data file and the sender is one of the effective judgment methods on the risk.

[Hardware Configuration Example]

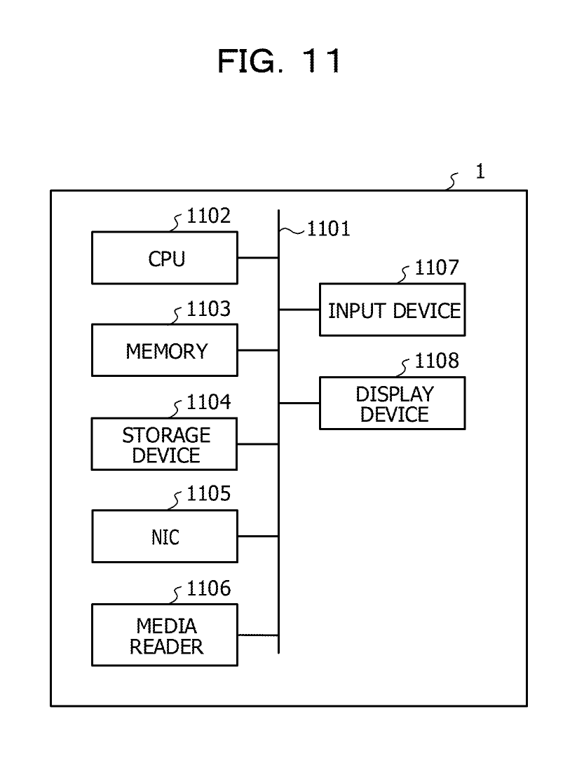

FIG. 11 is a diagram illustrating an example of a hardware configuration of the controller 1 in this embodiment. In addition, while FIG. 11 illustrates the example of the hardware configuration of the controller 1, the similar configuration may also be adopted in the MX server 2, the terminal devices 3-1 to 3-n, the mail server 4, the terminal devices 5-1 to 5-n, the external network 6, or the like, as described below.

The controller 1 is the information processor including a central processing unit (CPU) 1102, a memory 1103, a storage device 1104, a NIC 1105, a media reader 1106, an input device 1107, and a display device 1108 which are connected to each other by a bus 1101.

The CPU 1102 performs a variety of operation controls in the controller 1. The memory 1103 and the storage device 1104 store a program that executes various types of the processing described in this embodiment or a variety of data to be utilized in various types of the processing. The storage device 1104 is a storage medium such as a hard disk drive (HDD) or a solid state drive (SSD) or the like, for example.

The CPU 1102 reading, processing, and controlling programs stored in the memory 1103 or the storage device 1104, the respective functional sections included in the processing unit 110 illustrated in FIG. 3 may be realized. In addition, each of the memory 1103 and the storage device 1104 may function as the storage unit 120 described in FIG. 3. Note that the CPU 1102 may be replaced by such a hardware circuit as a micro processing unit (MPU), an application specific integrated circuit (ASIC), or the like.

The NIC 1105 is a hardware to be used in transmission and reception of data via a wired or wireless network. The NIC 1105 may function as the communication unit 101 under the control of the CPU 1102.

The media reader 1106 is a device configured to read data from a storage medium, and is, for example, a disk drive to read data stored in a disk medium or a card slot to read data stored in a memory card, or the like, such as the CD-ROM or DVD-ROM, or the like. Some or all of the data stored in the storage device 1104 as described above may be stored in a readable storage medium with the use of the media reader 1106.

The input device 1107 is a device configured to receive input or designation from a user (including a system administrator). Examples of the input device 1107 include a keyboard, a mouse, or a touch pad, or the like. The display device 1108 displays various types of information under the control of the CPU 1102. The display device 1108 is a liquid crystal display, for example.

Since a computer of the hardware configuration similar to that in FIG. 11 may be used for the MX server 2, the terminal devices 3-1 to 3-n, the mail server 4, the terminal devices 5-1 to 5-n, and the external network 6, a description thereof is omitted herein. A specific hardware (model or performance, or the like) of the CPU, the memory, the storage device, the NIC, the media reader, the input device, and the display unit may differ in each device, however.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
transmitting to a source device an inquiry regarding a file name of a data file received from the source device;
determining a consistency of the data file and the source device based on whether or not a file name corresponding to the file name of the data file is received from the source device in response to the inquiry; and
transmitting, to a destination device of the data file, data to enable the data file when the data file and the source device are determined to be consistent in the determining.

2. The non-transitory computer-readable storage medium according to claim 1, wherein
the determining determines that the data file and the source device are inconsistent when a file name not corresponding to the file name of the data file is received from the source device in response to the inquiry.

3. The non-transitory computer-readable storage medium according to claim 1, wherein
the determining determines that the data file and the source device are inconsistent when reception of any file name in response to the inquiry is not detected within a predetermined period of time after transmission of the inquiry.

4. The non-transitory computer-readable storage medium according to claim 1, wherein
the computer is a computer that is different from the destination device of the data file; and wherein
the process further comprises:
converting a first file name into a second file name, the first file name being the file name of the data file received from the source device and including an extension of the data file, the second file name having no association with an application corresponding to the extension;
transmitting to the destination device the data file with the second file name to which the file name is converted; and
transmitting the first file name to the destination device when the data file and the source device are determined to be consistent in the determining.

5. The non-transitory computer-readable storage medium according to claim 4, wherein
the first file name is not transmitted to the destination device when the data file and the source device are determined to be inconsistent in the determining.

6. The non-transitory computer-readable storage medium according to claim 4, wherein
the first file name is converted into the second file name by changing the entire first file name.

7. The non-transitory computer-readable storage medium according to claim 4, wherein
the first file name is converted into the second file name by changing a character string part corresponding to the extension of the first file name, based on a predetermined rule.

8. The non-transitory computer-readable storage medium according to claim 4, wherein
the first file name is converted into the second file name by using a conversion rule that differs depending on the character string included in the first file name or the extension of the data file.

9. The non-transitory computer-readable storage medium according to claim 4, wherein
the data file is an attachment file attached to a concerned e-mail that is transmitted from the source device and addressed to the destination device.

10. The non-transitory computer-readable storage medium according to claim 9, wherein
the inquiry is an inquiry e-mail addressed to a source address indicated in the concerned e-mail; and wherein
the first file name is transmitted to the destination device when a reply e-mail corresponding to the inquiry e-mail includes a character string that perfectly matches the first file name.

11. The non-transitory computer-readable storage medium according to claim 9, wherein
the concerned e-mail transmitted from the source device is an e-mail determined as a likely targeted attack mail based on a predetermined determination condition.

12. The non-transitory computer-readable storage medium according to claim 11, wherein
the predetermined determination condition includes that the concerned e-mail is determined to be the likely targeted attack when a predetermined character string is exist in a subject line or a text of the concerned e-mail.

13. A data file transmission method executed by a computer, the data file transmission method comprising:
transmitting to a source device an inquiry regarding a file name of a data file received from the source device;
determining a consistency of the data file and the source device based on whether or not a file name corresponding to the file name of the data file is received from the source device in response to the inquiry; and
transmitting, to a destination device of the data file, data to enable the data file when the data file and the source device are determined to be consistent in the determining.

14. An information processing apparatus comprising:
a memory; and
a processor coupled to the memory and the processor configured to execute a process, the process including:
transmitting to a source device an inquiry regarding a file name of a data file received from the source device;
determining a consistency of the data file and the source device based on whether or not a file name corresponding to the file name of the data file is received from the source device in response to the inquiry; and
transmitting, to a destination device of the data file, data to enable the data file when the data file and the source device are determined to be consistent in the determining.
